(19) United States
(12) Patent Application Publication
(10) Pub. No.: US 2016/0334906 A1
(43) Pub. Date: Nov. 17, 2016

(54) SYSTEM AND METHOD FOR DETECTING AN END-USER ACTION REGARDING AN OBJECT BASED ON HEURISTICS

(71) Applicant: Zheng Shi, Beijing (CN)

(72) Inventor: Zheng Shi, Beijing (CN)

(21) Appl. No.: 15/221,619

(22) Filed: Jul. 28, 2016

Related U.S. Application Data
(63) Continuation-in-part of application No. 14/696,497, filed on Apr. 27, 2015.
Application No. 14/696,497 is a continuation of application No. PCT/CN2014/090890, filed on Nov. 12, 2014.

(51) Int. Cl. G06F 3/044; G06F 3/041

(52) U.S. Cl. CPC G06F 3/044; G06F 3/0416

(57) ABSTRACT

The present invention discloses a system and method to enable a capacitance sensor to further recognize a capacitive action on an object after the capacitance sensor has recognized the presence of the object. The system includes an object, an interactive surface embedded with a capacitance sensor, and a processor that is configured to continuously receive capacitance values from the capacitance sensor. After an object is placed on an interactive surface and within the detection range of the capacitance sensor, the processor is configured to deduce that a first significant change in capacitance value has occurred, and that an object has been placed on the interactive surface, based on one or more heuristics. And further, once an end-user touches the object, the processor is configured to deduce that a second significant change in capacitance value has occurred, and that the object has been touched by a finger, based on one or more heuristics. The present invention may be valuable for a variety of education, entertainment and productive applications by providing enhanced human machine interactivity through the manipulation of physical objects.

### CROSS-REFERENCE TO RELATED APPLICATION

This application is a continuation in part of application Ser. No. 14/696,497, entitled “System and Method for Recognizing Objects with Continuous Capacitance Sensing”, filed on Apr. 27, 2015, which is a continuation of International Patent Application No. PCT/CN2014/090890, entitled “System and Method for Recognizing Objects with Continuous Capacitance Sensing”, filed on Nov. 12, 2014.

The entire disclosures of each of the above applications are incorporated herein by reference.

### TECHNICAL FIELD

The present invention relates to object recognition on an interactive surface, for enhancing the interactivity of an end-user with a computer through manipulation of physical objects, using capacitive sensor technology.

### BACKGROUND

The recent abundance of inexpensive computer processors has greatly improved games, toys, books, musical instruments and the like. Increasingly, embedded sensors, coupled with processors linked to sensory accessories such as audio and video devices, are used in games to enrich the interactive experience of the players.

Typically, computerized games provide players with a visual display of the game activity through an electronic display system, such as a pixilated flat panel display or a touch screen. However, such displays are not three-dimensional, which prevents the physical interaction inherent in traditional board-based games. For example, a traditional board game may use one or more movable game pieces that players (especially young ones) find more “natural” and easier to interact with. On the other hand, traditional board games often lack the audio and/or visual interaction that computerized games can offer. Therefore, gaming methods that combine computerized technology with physical play will enhance players gaming experience.

Thus, it is desirable to develop a system and method that allows physical objects to be identified and located in a physically bounded environment by means of a computerized system. For example, allowing a computerized system to recognize both the identity of a board game piece and its location on the game board can enhance a player's experience by allowing their physical actions to be recognized and interpreted by the computer system so as to provide real-time feedback to the player by a multitude of sensorial accessories such as video and/or audio outputs.

### SUMMARY OF THE INVENTION

The present invention discloses a system and method to enable a capacitance sensor to further recognize an end-user finger touch on an object after the capacitance sensor has already recognized the presence of the object.

In accordance with one embodiment of the present invention, the system includes an object, an interactive surface embedded with a capacitance sensor, and a processor that is configured to continuously receive capacitance values from the capacitance sensor.

In accordance with one embodiment of the present invention, after an object is placed on an interactive surface and within the detection range of a capacitance sensor, the processor is configured to deduce that a first significant change in capacitance value has occurred, and that an object has been placed on the interactive surface, based on one or more heuristics. Furthermore, once an end-user touches the object, the processor is configured to deduce that a second significant change in capacitance value has occurred, and that the object has been touched by a finger, based on one or more heuristics.

In accordance with one embodiment of the present invention, the method includes the steps of: receiving continuously, by a processor, capacitance values from a capacitance sensor that is embedded in an interactive surface; deducing, by the processor and after an end-user places an object on the interactive surface and within the detection range of the capacitance sensor, that a first significant change in capacitance value has occurred, and that an object has been placed on the interactive surface, based on one or more heuristics; further deducing, by the processor and after the end-user touches the object, that a second significant change in capacitance value has occurred, and that the object has been touched by a finger, based on one or more heuristics.

In accordance with one embodiment of the present invention, the system and method further includes a unique identification code (UID) embedded in the object and a reader embedded in the interactive surface with the detection range of the reader configured to encompass the detection range of the capacitance sensor. The processor is configured to instruct the reader to read the UID of the object after the processor has deduced that the object has been placed on the interactive surface.

In accordance with one embodiment of the present invention, the processor is configured to deduce that a significant change in capacitance value has occurred based on a threshold heuristic.

In accordance with one embodiment of the present invention, the processor is configured to deduce that a significant change in capacitance value has occurred based on a standard deviation heuristic.

In accordance with one embodiment of the present invention, the system further includes an array of capacitance sensors embedded within the interactive surface, an array of readers embedded within the interactive surface, and multiple objects.

In accordance with one embodiment of the present invention, the object is fully or partially made of high dielectric constant material.

The present invention may be valuable for a variety of education, entertainment and productive applications by providing enhanced human-machine interactivity through the manipulation of physical objects.

### BRIEF DESCRIPTION OF THE DRAWINGS

To better illustrate the technical features of the embodiments of the present invention, various embodiments of the present invention will be briefly described in conjunction with the accompanying drawings. It should be obvious that the drawings are but for exemplary embodiments of the present invention, and that a person of ordinary skill in the art may derive additional drawings without deviating from the principles of the present invention.

FIG. 1 is an exemplary schematic diagram for the basic components of the system in accordance with an embodiment of the present invention.

FIG. 2 is an exemplary schematic diagram for the process flow of the method for the system in FIG. 1 in accordance with an embodiment of the present invention.

FIG. 3 is an exemplary chart illustrating the capacitance value changes experienced by a capacitance sensor and received by a processor in accordance with an embodiment of the present invention.

FIG. 4 is an exemplary schematic diagram for a system having an array of capacitance sensors and readers embedded within the interactive surface and multiple objects placed upon its surface in accordance with an embodiment of the present invention.

### DETAILED DESCRIPTION OF THE INVENTION

To better illustrate the purpose, technical feature, and advantages of the embodiments of the present invention, various embodiments of the present invention will be further described in conjunction with the accompanying drawings.

While the present invention will be described in connection with various specific embodiments, the invention is not limited to these embodiments. People skilled in the art will recognize that the system and method of the present invention may be used in many other applications.

For example, the notion of “surface” or “interactive surface” is discussed for the sake of simplicity, but the present invention can easily be applicable in three dimensions, whereby objects are placed on the side of or at the bottom of the interactive surface, such as by using magnets to get the objects to stick to a vertical or upside down surface.

In addition, while a specific capacitance sensor array and a specific antenna array design are disclosed in connection with embodiments of the present invention, other array designs can also be used and are within the scope of the present invention.

Furthermore, while a specific communication flow between the processor, the RF antenna array, and multiple objects' RFID chips, is disclosed in connection with embodiments of the present invention, the embodiments of the present invention is not limited to any particular process by which the UID of the object is detected by the interactive surface.

The present invention may be better understood and its objects and advantages will become more apparent to those skilled in the art by reference to the accompanying drawings.

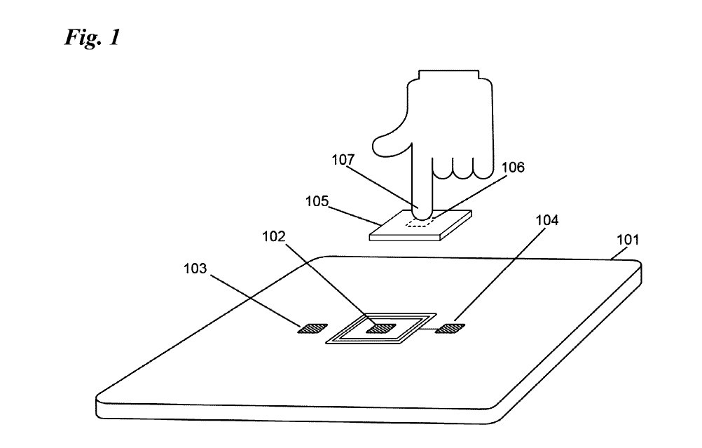

FIG. 1 is an exemplary schematic diagram for the basic components of the system in accordance with an embodiment of the present invention.

The interactive surface 101 is embedded with a capacitance sensor 102, a processor 103, and a reader 104. The processor 103 is operatively connected to both the capacitance sensor 102 and the reader 104, and further configured to continuously receive capacitance values from the capacitance sensor 102. The reader 104 is configured so that the detection range of the reader 104 encompasses the detection range of the capacitance sensor 102.

FIG. 1 further shows an object 105 made of high dielectric constant material that is capable of being detected by the capacitance sensor and embedded with an RFID tag 106 containing the object's 105 unique identification code (UID) placed upon the interactive surface 101. An end-user's finger 107 is also touching the object 105. An example of a high dielectric constant material is plastic mixed with small amount of carbon black powder or metal powder.

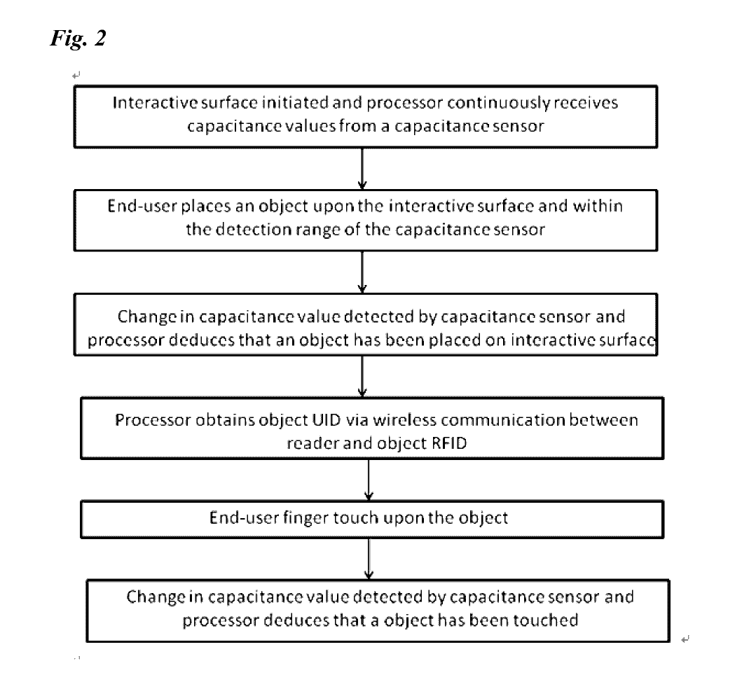

FIG. 2 is an exemplary schematic diagram for the process flow of the method for the system in FIG. 1 in accordance with an embodiment of the present invention.

The process of the system is as follows. Once initiated, the processor 103 of the interactive surface 101 continuously receives capacitance values from the capacitance sensor 102. Whenever an end-user places an object 105 upon the interactive surface 101 and within the detection range of the capacitance sensor 102, a first significant change in capacitance value is detected by the capacitance sensor 102 and the processor 103 infers that an object 105 has been placed on the interactive surface 101 based on one or more heuristics. The processor 103 proceeds to instruct the reader 104 to read the RFID tag of the object 105 and obtain its UID via wireless communication. A subsequent finger touch 107 by the end-user on the object 105 causes a second significant change of capacitance value which is detected by the capacitance sensor 102 and the processor 103 further infers, based on one or more heuristics, that the object 105 has been touched by a finger 107.

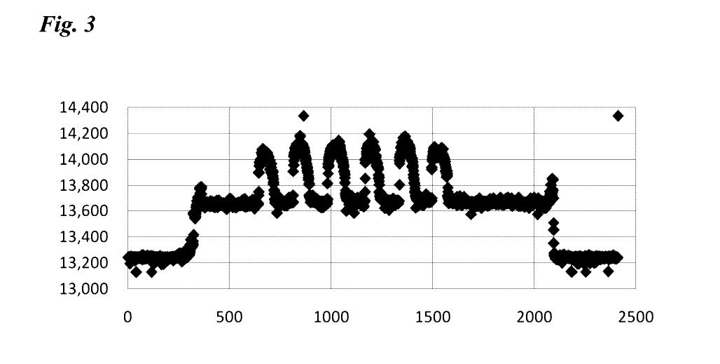

FIG. 3 is an exemplary chart illustrating the capacitance value changes experienced by a capacitance sensor and received by a processor that is configured to continuously receive capacitance values from the capacitance sensor in accordance with an embodiment of the present invention.

In FIG. 3, the y-axis depicts the capacitance value and the x-axis depicts the time as a unit of 30 milliseconds. Time starts at 0 and finishes at 2500 milliseconds and thus, the entire duration of the period depicted in FIG. 3 is equal to 75 seconds. Each point depicted in the chart represents the capacitance value detected by a capacitance sensor 102 and received by the processor 103 at a specific point in time.

At time 0 to 300, the capacitance sensor 102 detects a more or less constant capacitance value of around 13200. Thereafter, an end-user places an object 105 on the capacitance sensor 102, causing the capacitance value to increase to above 13600 between time 300 to 600. As long as the object 105 remains on top of the capacitance sensor 102, the capacitance value will remain relatively constant at that new base value.

Between time 600 to 1600 the end-user proceeds to touch the object six times which causes 6 consecutive peaks in capacitance value. The peak value is around 14100 when the end-user is touching the object 105. As the finger is removed from the object 105 the capacitance values return to the new base capacitance value of around 13600. At time 2100 the object 105 is removed from the capacitance sensor 102 and the capacitance value decreases to a base value of around 13200.

As FIG. 3 illustrates, in practice, only placement of object made of high dielectric constant material on the interactive surface and an end-user touch 107 upon the object 105 will raise the capacitance value significantly.

The processor is configured to deduce that an object has been placed on the sensor, and that a finger touch has occurred upon the object while the object remains on the sensor, based on one or more heuristics.

In one embodiment of the present invention, the processor 103 is configured to detect the presence of an object 105 and subsequent finger touch 107 upon the object 105 via a threshold heuristic by which, once an increase in capacitance value exceeds a first predefined threshold value, the processor is configured to recognize a specific action (e.g., object 105 placed on the capacitance sensor 102 or end-user finger touch 107 on the object 105).

In another embodiment of the present invention, the processor 103 is configured to detect the presence of an object 105 and subsequent end-user finger touch 107 upon the object 105 via a standard deviation heuristic by which the processor is configured to use the standard deviation of a segment of capacitance value changes to deduce the end-user's actions. Standard deviation of a segment of capacitance values tend to increase dramatically when an object 105 is placed on the capacitance sensor 102, or whenever an end-user finger 107 touches the object 105. This could be due to a significant increase in capacitance value or due to the fact that when the object 105 is dropped on the capacitance sensor 102, or whenever the end-user finger is touching the object 105, the relative location and contact of the object 105 relative to the capacitance sensor tends to shift, resulting in changes in capacitance value itself.

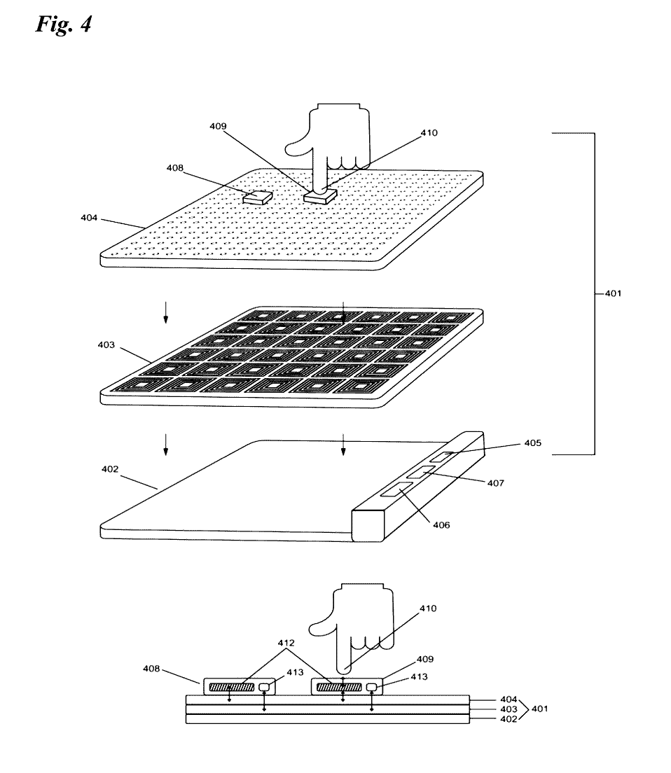

FIG. 4 is an exemplary schematic diagram for a system having an array of capacitance sensors and readers embedded within the interactive surface and multiple objects placed upon its surface in accordance with an embodiment of the present invention.

The interactive surface 401 consists of three superimposed layers and a peripheral unit. The first layer 402 consists of the substrate or base of the interactive surface. The second layer consists of an RF antenna array 403 whose function is to wirelessly determine the UID of an object's RFID. The third layer consists of an array of capacitance sensors 404 whose purpose is to detect the location and orientation of objects placed upon the interactive surface 401. In the particular embodiment described in FIG. 4, each capacitance sensor is assigned to the RF antenna closest to it. Finally, the peripheral unit consists of the interactive surface's 401 processor 405, memory unit 406 and power source 407.

FIG. 4 further shows a number of objects placed upon the surface of the interactive surface 401. One object 408 has been placed alone and another object 409 is further being touched by the finger 410 of an end-user. Each object 409, 410 is embedded with both a capacitance tab 412 and an RFID tag 413.

The process of the present invention will better be understood by describing how two different scenarios function within the premise of the present invention.

In the first scenario, an object 408 embedded with a capacitance tab 412 has been place upon the interactive surface 401, causing the interactive surface's 401 capacitance sensors 404 to detect a significant change in capacitance value, and the processor 405 deduces that this is attributable to an object 408 being placed upon the interactive surface 401. This causes the processor 405 to direct the RF antenna assigned to these capacitance sensors 404 to read the UID of the object's 408 RFID tag 413. Once the processor 405 has determined the location and UID of the object 408 it stores this information into its memory 406.

In the second scenario, once the object 409 is placed on the interactive surface 401 and its location and UID is determined by the processor 405 using the same process as described in the first scenario, an end-user then proceeds to touch the object 409 with a finger 410. Doing so causes those capacitance sensor(s) 404 under the object 409 that have already detected the object 409 to detect a further change in capacitance value above that experienced by only placing the object 409 which the processor 405 deduces is attributable to an end-user touch on the object 409.

1. An interactive system for detecting an end-user action regarding an object, comprising,
an object,
an interactive surface embedded with a capacitance sensor,
a processor configured to continuously receive capacitance values from the capacitance sensor,
wherein, upon an end-user placing the object on the interactive surface and within the detection range of the capacitance sensor, the processor is configured to deduce that a first significant change in capacitance value has occurred, and that an object has been placed on the interactive surface, based on one or more heuristics, and wherein, further upon the end-user touching the object, the processor is configured to deduce that a second significant change in capacitance value has occurred, and that the object has been touched by a finger, based on one or more heuristics.

2. The interactive system in claim 1, further comprising
a unique identification code (UID) embedded in the object, and
a reader embedded in the interactive surface, and the detection range of the reader encompasses the detection range of the capacitance sensor,
wherein, the processor is configured to instruct the reader to read the UID of the object, after the processor has deduced that the object has been placed on the interactive surface.

3. The interactive system in claim 1, wherein, the processor is configured to deduce that a significant change in capacitance value has occurred based on a threshold heuristic.

4. The interactive system in claim 1, wherein, the processor is configured to deduce that a significant change in capacitance value has occurred based on a standard deviation heuristic.

5. The interactive system in claim 1, further comprising an array of capacitance sensors embedded within the interactive surface, an array of readers embedded within the interactive surface, and a plurality of objects.

6. The interactive system of claim 1, wherein, the object is fully or partially made of high dielectric constant material.

7. An interactive method for detecting an end-user action regarding an object, comprising,
receiving continuously, by a processor, capacitance values from a capacitance sensor that is embedded in a interactive surface,
deducing, by the processor and upon an end-user placing an object on the interactive surface and within the detection range of the capacitance sensor, that a first significant change in capacitance value has occurred, and that an object has been placed on the interactive surface, based on one or more heuristics,
further deducing, by the processor and upon the end-user touching the object, that a second significant change in capacitance value has occurred, and that the object has been touched by a finger, based on one or more heuristics.

8. The interactive method in claim 7, further comprising
instructing, by the processor, a reader to read the UID of the object, after the processor has deduced that the object has been placed on the interactive surface, whereby the reader is embedded in the interactive surface and its detection range encompasses the detection range of the capacitance sensor, and the UID is embedded in the object.

9. The interactive method in claim 7, further comprising
deducing, by the processor, that a significant change in capacitance value has occurred based on a threshold heuristic.

10. The interactive method in claim 7, further comprising
deducing, by the processor, that a significant change in capacitance value has occurred based on a standard deviation heuristic.

11. The interactive method in claim 7, further comprising an array of capacitance sensors embedded within the interactive surface, an array of readers embedded within the interactive surface, and a plurality of objects.

12. The interactive method in claim 7, wherein, the object is fully or partially made of high dielectric constant material.
